(19) United States
(12) Patent Application Publication
(10) Pub. No.: US 2008/0029557 A1
(43) Pub. Date: Feb. 7, 2008

(54) Closeable adjustable flow spout with tethered protective cap for a beverage container

(75) Inventor: Jorge E. Moran, Nashville, TN (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Megatrade International, Inc., Nashville, TN (US)

(21) Appl. No.: 11/496,725

(22) Filed: Aug. 1, 2006

(51) Int. Cl. B67D 3/00

(52) U.S. Cl. 222/543

(57) ABSTRACT

A beverage container closure with a spout and cap that includes a base which contains a threaded inner wall to be attached to a beverage container by twisting on to mating threads of a beverage container. The base contains an aperture extending through it for conveying the fluid from the beverage container. The base further contains a narrower central portion with a threaded outer wall for selectively mounting a protective outer cap. The base further contains a ring around its lower perimeter attached to a retaining strap which fastens to the protective outer cap. The base further contains a flow control spout assembly. The flow control spout assembly is mounted to the central portion of the base and optionally rotatable. The flow control spout assembly has a lower portion with vertically grooved outer walls to facilitate grip when rotating. The flow control spout assembly contains a tubular spout including a central plug which alternates between an open and closed position corresponding with the rotation of the flow control spout. The protective outer cap is of sufficient depth to cover the flow control spout assembly whereby the tip of the flow control assembly will seal against the inner top of the protective cap when the cap is secured. The cap has threaded inner walls mating with the threads of the lower portion of the flow control assembly for optionally securing the cap to the flow control assembly and the cap has a fastener on the top to which a tether is securely and rotatably attached.

### FIELD OF THE INVENTION

Embodiments of the present invention relate to closable spouts for beverage containers.

### BACKGROUND OF THE INVENTION

Users of beverage containers often would frequently like a closure that is re-sealable and re-usable while protecting the container openings from contaminants and damage. Additionally users of beverage containers frequently desire a reusable container closure which enables adjustable flow control for pouring or consumption of the beverage. It is desirable to combine such elements into a container closure that does not contain separate components which may be lost or misplaced.

Container closures which are not able to be closed after the initial opening are not suitable for sports beverage containers. Closures which are not able to be closed after the initial opening do not protection the beverage from spoiling, contaminants or spilling. Closures which have separate components risk losing a separate component such as a cap once the closure is opened. Such a loss is more likely when a consumer is walking or driving or otherwise active while using the container. Beverage container closures which do not have adjustable openings to provide flow control while consuming or pouring a beverage are also undesirable. Container spouts which do not allow for flow control are either permanently restricted in flow or risk spilling if their flow can not be restricted when pouring or consuming during driving or other active pursuits.

These and other drawbacks exist with current systems.

### BRIEF DESCRIPTION OF THE DRAWINGS

FIG. 1 depicts a schematic illustrating an exemplary embodiment of the flow controlling closure with protective cap and retaining strap.

FIG. 2 depicts an isometric view illustrating an exemplary embodiment of closure 10 fastened to a flask.

### DETAILED DESCRIPTION OF EXEMPLARY EMBODIMENT(S)

Exemplary embodiments of the invention are discussed in detail below. While specific exemplary embodiments are discussed, it should be understood that this is done for illustration purposes only. A person skilled in the relevant art will recognize that other components and configuration can be used without departing from the spirit and scope of the invention.

Various embodiments discussed herein overcome the problems of existing closures by providing one or more of the following elements:

adjustable flow controlling spout 40; protective cap 20; and base 30.

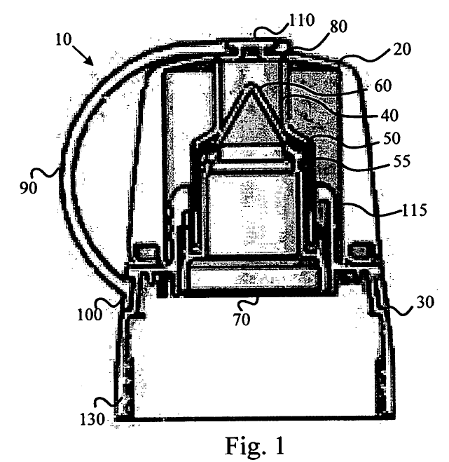

FIG. 1 depicts a schematic illustrating an exemplary embodiment of the present invention. Closure 10 includes adjustable flow controlling spout 40, protective cap 20, and base 30.

Base 30 contains inner threaded walls 130 for mating with the threads of a beverage container. Base 30 contains a ring 100 around its lower perimeter attached to a retaining strap which fastens to protective outer cap 20. Base 30 may contain insulation in the walls to help maintain the desired beverage temperature. Base 30 contains a narrower central portion with a threaded outer wall 115 for mating with the threads of an outer protective cap 20. Base 30 further containing adjustable flow controlling spout 40.

Adjustable flow controlling spout 40 contains an aperture throughout from the tip of the adjustable flow controlling spout 80 to aperture 70 in the base 30 of closure 10. Adjustable flow controlling spout 40 contains stopper 55 with plug 60 mounted on top which optionally seals adjustable flow controlling spout 40. Stopper 55 and plug 60 alternate between a raised position in which it seals spout 40 and a lowered position in which spout 40 is fully open. The position of plug 60 is controlled by rotating the central portion of the flow control assembly 50 which rotates within base 30 to raise or lower plug 60 in gradual increments corresponding to the amount of rotation of flow control assembly 50. Flow control assembly 50 contains inner threaded walls mating with threads on stopper 55 which guide the rotation of flow control assembly 50 and stopper 55. Flow control assembly 50 contains vertical grooves on the exterior wall to facilitate finger traction for rotation. Flow control assembly 50 may allow a user of closure 10 to seal a beverage container. Flow control assembly 50 may allow a user to control the rate of flow of the beverage from the closure and may help reduce spillage and waste of the beverage.

Protective outer cap 20 contains an inner threaded wall for mating with the threads on the central portion of base 30 and optionally securing cap 20 to base 30. Protective outer cap 20 is of sufficient depth to cover adjustable flow controlling spout 40. Protective outer cap 20 contains a fastener 110 on the top of the cap with attached to a retaining strap 90 which is secured to base 30. Fastener 110 permits cap 20 to rotate while remaining fastened to retaining strap 90. This enables cap 20 to be rotated for securing onto base 30 or removing from base 30. Retaining strap 90 prevents the loss or misplacement of protective outer cap 20 when protective outer cap 20 is not secured to base 30. Protective outer cap 20 protects spout 40 from contaminants and damage. Outer cap 20 may also reduce spillage from spout 40 if a user leaves plug 60 of the flow control assembly in an open position but secures outer cap 20 to base 30. Outer cap 20 may contain insulation and help maintain a desired beverage temperature.

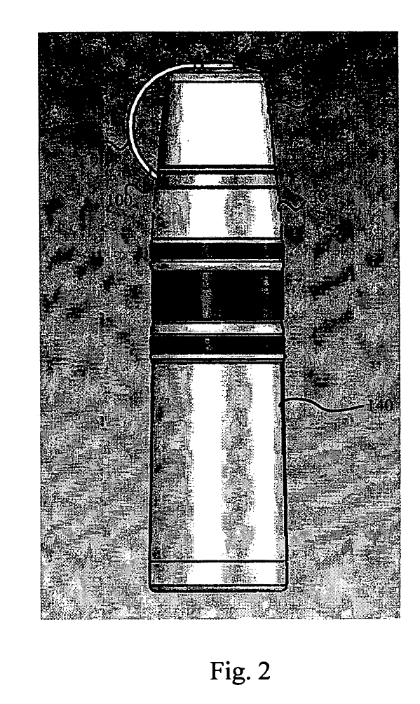

FIG. 2 depicts a view illustrating an exemplary embodiment of closure 10 fastened to a flask 140. Base 30 is shown mounted on flask 140. Ring 100 is shown on base 30, securing a first end of retaining strap 90. A second end of retaining strap 90 is rotatably secured to fastener 110 on the top of protective cap 20. In some embodiments, Closure 10 and protective outer cap 20 are formed from plastic. In some embodiments, Closure 10 and protective outer cap 20 are formed from ABS plastic. In some embodiments, Closure 10 and protective outer cap 20 are comprised of materials that are dishwasher safe.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A beverage container closure with a spout and cap comprising:
a base which contains a threaded inner wall to be attached to a beverage container by twisting on to mating threads of a beverage container, the base containing an aperture extending through it for conveying the fluid from the beverage container, the base further containing a narrower central portion with threaded outer wall for selectively mounting a protective outer cap, the base further containing a ring around its lower perimeter attached to a retaining strap which fastens to the protective outer cap, the base further containing a flow control spout assembly;
the flow control spout assembly mounted to the central portion of the base and optionally rotatable, the flow control spout assembly having a tubular spout including a central plug which alternates between an open and closed position corresponding with the rotation of the flow control spout,
the protective outer cap of sufficient depth to cover the flow control spout assembly whereby the tip of the flow control assembly will seal against the inner top of the protective cap when the cap is secured and the cap having threaded inner walls mating with the threads of the lower portion of the flow control assembly for optionally securing the cap to the flow control assembly; and the cap having a fastener on the top to which a tether is securely and rotatably attached.

2. The closure of claim 1 wherein the protective outer cap and the base of the flow control assembly are insulated for use with insulated beverage containers.

3. The closure of claim 1 wherein the closure is made from plastic.

4. The closure of claim 1 wherein the closure is cylindrically shaped and the base of the closure forms a smooth seam with the protective cap fastened to the base.

5. The closure of claim 1 wherein the flow control spout assembly has a lower portion with vertically grooved outer walls to facilitate grip when rotating.

6. The closure of claim 1 wherein the closure is made from ABS plastic.

7. The closure of claim 1 wherein the closure is made from materials that are dishwasher safe.
